(19) United States
(12) Patent Application Publication
(10) Pub. No.: US 2014/0040158 A1
(43) Pub. Date: Feb. 6, 2014

(54) SYSTEMS AND METHODS FOR MANAGING ARRESTED PERSONS

(71) Applicants: Kenneth L. Dalley, JR., Otsego, MN (US); Brett Wilmeth, Hanover, MN (US)

(72) Inventors: Kenneth L. Dalley, JR., Otsego, MN (US); Brett Wilmeth, Hanover, MN (US)

(21) Appl. No.: 13/563,446

(22) Filed: Jul. 31, 2012

(51) Int. Cl. G06Q 10/00

(52) U.S. Cl. 705/342

(57) ABSTRACT

The disclosure relates to systems and methods of arrestee management. An arrestee management system may comprise a document arrest module configured to manage an arrest process, a document departure module configured to manage a process of preparing a transport vehicle for departure and help verify that all arrestees are on the transport vehicle prior to departure, and a document arrival module configured to manage a process of removing an arrestee from the transport vehicle at a destination of the transport vehicle and help verify that all arrestees on the transport vehicle prior to transport are on the transport vehicle at the destination.

### BACKGROUND INFORMATION

Law enforcement agencies face logistical, communication, and records management challenges when managing arrestees (e.g. suspects or detainees). This includes processing, transporting, and caring for suspects while under arrest, and collecting a wide range of information about each of the arrestees while in custody.

### BRIEF DESCRIPTION OF THE DRAWINGS

FIG. 1 illustrates an arrestee management system according to an example embodiment.

FIG. 2 illustrates an arrestee management system according to an example embodiment.

FIG. 3 illustrates a system level arrestee management system application flowchart according to an example embodiment.

FIG. 4 illustrates a flow diagram of a method implemented by a document arrest module according to an example embodiment.

FIG. 5 illustrates a flow diagram of a method implemented by a document departure module according to an example embodiment.

FIG. 6 illustrates a flow diagram of a method implemented by a document arrival module according to an example embodiment.

FIG. 7 illustrates a flow diagram of a method implemented by a document meal module according to an example embodiment.

FIG. 8 illustrates a flow diagram of a method implemented by a document booking stage module according to an example embodiment.

FIG. 9 illustrates a flow diagram of a method implemented by a document arrestee check module according to an example embodiment.

FIG. 10 illustrates a flow diagram of a method implemented by a document arrestee request module according to an example embodiment.

FIG. 11 illustrates a flow diagram of a method implemented by a document arrestee removal module according to an example embodiment.

FIG. 12 illustrates a flow diagram of a method implemented by a document property module according to an example embodiment.

FIG. 13 illustrates a user interface for an arrestee management system according to an example embodiment.

FIG. 14 illustrates an output screenshot of an arrestee management system according to an example embodiment.

FIG. 15 illustrates a computer system to implement an arrestee management system according to an example embodiment.

### DETAILED DESCRIPTION

Various embodiments illustrated and described herein provide solutions to efficiently and accurately process and manage an arrestee, or a large group of arrestees such as a group of arrestees at a protest. These and other embodiments are described, with reference to the figures, herein.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to limit the scope of this application to any single invention or inventive concept if more than one is in fact disclosed. The following description is, therefore, not to be taken in a limited sense, and the scope of the inventive subject matter is defined by the appended claims.

The functions or algorithms described herein are implemented in hardware, software, or a combination of software and hardware in some embodiments. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely embodiments. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flows are applicable to software, firmware, and hardware implementations.

Systems and methods of the present disclosure may be implemented on a mobile device as a mobile application, web-based application, on a desktop computer as a computer application, or a combination thereof. A mobile application may operate on a Smartphone, tablet computer, portable digital assistant (PDA), ruggedized mobile computer, or other mobile device. The mobile device may be connected to the Internet or network via Wi-Fi, Wide Area Network (WAN), cellular connection, WiMax, or any other type of wired or wireless method of networking connection. In some embodiments, a web-based application may be delivered as a software-as-a-service (SaaS) package (e.g. cloud-based embodiments) accessible via a device app, a web browser application, or other suitable application, depending on the particular embodiment.

### Overview

The disclosure presents methods and apparatuses to electronically process and manage arrestees (e.g. detainees or suspects) including the ability to capture a wide range of data about arrestees during transport activities, requests made by an arrestee, law enforcement observations of the arrestee, and interactions a user (e.g. a law enforcement official) may have with an arrestee while in custody, among other things.

Law enforcement agencies face logistical, communication, and records management challenges when managing a group of arrestees. This includes processing, transporting, providing care, and collecting a wide range of information about each of the arrestees while in custody. Various embodiments illustrated and described herein include systems, methods, and software to assist in such situations. For example, typical embodiments assist in rapid recording and monitoring a wide range of data about arrestees including requests made by arrestees, transport activity, behavioral and health-related observations, and other activities pertinent to managing and documenting activities of and with regard to arrestees. Such embodiments may do so in a user-friendly and efficient manner via a networked computing environment.

Law enforcement officials manage many responsibilities including a significant amount of documentation in order to capture data pertinent to each arrestee from the time of arrest to the time of incarceration. Law enforcement may face challenges in managing arrestees from identifying suspects and tracking their location throughout the arrest to detention process to threats of litigation for making an arrestee spend an unreasonable amount of time in custody, for ignoring or denying an arrestee request, or for not offering an arrestee a meal, among other embodiments. To help mitigate such risks, some embodiments herein include systems, methods, and software that may provide warnings or alerts to law enforcement officials regarding such risks. Example warnings or alerts may include warnings that a duty is owed to an arrestee such as offering the arrestee a meal, alerting that the arrestee has been in custody too long without a “well-being check,” or warning that not all arrestees that are supposed to be present in a particular location are present, among other warnings or alerts.

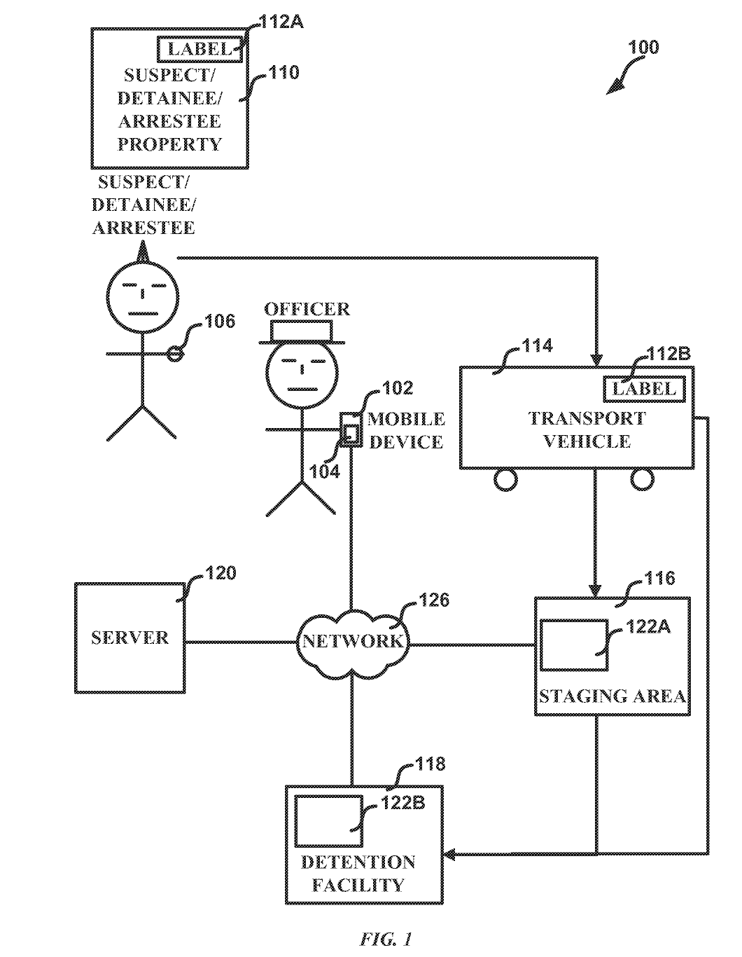

FIG. 1 is an illustration of an arrestee management system 100, according to an example embodiment. The illustrated arrestee management system 100 includes a user such as a law enforcement officer with a mobile device 102 that includes an RFID or barcode reader 104. In some embodiments, the RFID or barcode reader may be a standalone RFID or barcode reader. The mobile device 102 may be coupled to network 126 such as through one or more of various wireless network types. The network 126 may also be coupled to computer 122A in or near a staging area 116, a computer 122B in or near a detention facility 118, or a server 120. RFID or barcode reader may be operable to scan an RFID or barcode wristband 106 or RFID or barcode label 112A or 112B. The mobile device 102 or a standalone RFID reader may send data corresponding to the RFID or barcode scan to the network 126. The network 126 may then transport the data to the server 120, or computer 122A or 122B.

In some example embodiments, an arrestee management system such as arrestee management system 100 may include software implemented in concert with a radio frequency identification (RFID) reader or barcode reader such as RFID or barcode reader 104 and RFID tags such as RFID or barcode wristband 106 or RFID or barcode label 112A or 112B. The RFID or barcode wristband, in some embodiments, may be a hand-restraint mechanism (i.e., “cuffs”) having an RFID tag embedded in or attached thereto or a barcode affixed or printed thereon. Multiple RFID or barcode tags may be associated with the same arrestee. For example, an RFID or barcode tag may be attached to an arrestee/suspect via a wristband such as RFID or barcode wristband 106, the personal property of the arrestee such as RFID or barcode label 112A on suspect/arrestee property 110, or a transport vehicle the arrestee is seated in such as RFID or barcode label 112B on transport vehicle 114, among others. In some embodiments, when an RFID wristband attached to an arrestee is scanned and an RFID tag attached to the personal property of the arrestee is scanned, the system may indicate that the wristband and the personal property are associated with the same arrestee. In some embodiments, scanning an RFID tag may cause a computer display to display an image of the arrestee associated with the tag. Similarly, in some embodiments, scanning an RFID of barcode tag may cause a computer to display an image of an identification key (e.g. master booking number) associated with the arrestee.

In some embodiments, an officer may apprehend an arrestee. The officer may affix an RFID or barcode wristband 106 to the arrestee and scan an RFID chip embedded therein with an RFID reader 104 of the mobile device 102. The officer may further enter additional data with regard to the arrestee, such as a picture captured with a camera of the mobile device 102, enter a location at which the arrestee was apprehended, and information with regard to why the arrestee was apprehended. The officer may then place the arrestee in a transport vehicle 114 and enter data indicating placement of the arrestee in the transport vehicle 114. Entry of such data may include scanning an RFID tag or barcode 112B of the transport vehicle and of the arrestee wristband. The data entered by the officer into the mobile device 102 at various points may be uploaded to the server 120 via the network. Further data may be uploaded to the server 120 such as a user performing actions, observations, and the arrestee making a request. The uploading may be accomplished using the mobile device 102 or other computing device connected to the network. The server 120 may record the received data based on an identifier of the RFID or barcode wristband 106 and apply rules to monitor various policies, regulatory and statutory compliance, and other issues that may be identified in the received data. Through such embodiments, data associated with arrestees may be rapidly collected, correlated on the server 120, and monitored to facilitate high compliance, accountability, and safety for arrestees, the public, and users such as law enforcement personnel.

Some such systems and methods may be customizable. The customizable features may include assigning users to user groups; managing user groups; enabling or disabling electronic system communication to user groups such as sending automatic system alerts or warnings, emails, text messages, reports, or the like to specific user groups or users; creating and managing lists of transport vehicles; creating and managing lists of law enforcement officers and their associated agencies; or creating and managing a list of identification keys (e.g. master booking numbers). In some embodiments, the list of identification keys may be a fixed, pre-existing set of master booking numbers. In some embodiments, an identification key may be associated with an arrestee who does not possess valid photo identification (ID) at the time of arrest. In some embodiments, validating the ID of the arrestee may be accomplished by iris scan, biometric or fingerprint technology, or voiceprint. In some embodiments, an identification key may be associated with a pair of handcuffs that may be attached to an arrestee at or around the time a user apprehends an arrestee. In some embodiments, a user may obtain personal information about an arrestee some time after arrest.

The alerts of various embodiments may be provided in a number of ways. For example, alerts may be broadcast to handheld or mobile devices of users such as arresting officers, transporting officers, corrections officers, and other users. Alerts in some embodiments may trigger an audible signal to be broadcast via a radio network at a particular frequency or channel such as a frequency or channel utilized by law enforcement generally or for a particular event, such as a public protest, where mass arrests may be likely.

Another customizable feature may include creation and management of locations and sub-locations of personnel and assets, including the locations which users may be transferring arrestees to or from, whether temporary or permanent. A sub-location may be one or more places within a location. For example, a sub-location may include a booking area within a location area named “detention facility.” In another embodiment, there may be multiple booking stations or stages within a location named “detention facility” that may be represented as sub-locations. In some embodiments, a location such as a city, may be broken up into sectors. In some embodiments, locations may be identified using global positioning system (GPS) coordinates.

Another customizable feature may include managing and recording an amount of time that has lapsed since an event such as an arrestee being arrested, placed on a transport vehicle, or other action that may be pertinent for reporting or compliance purposes has occurred. Managing and recording an amount of time that has lapsed may include presenting an amount of travel time expected during a segment of transportation.

Another customizable feature may include creating, enabling, or disabling alerts or warnings related to lapsed times. If an alert or warning is enabled and a lapsed time exceeds a threshold, an alert or warning may be triggered. The alert or warning may be shared automatically with one or more user groups or users. In some embodiments, an alert or warning may include sending a communication alerting a user or user group that a variance in a headcount exists or a compliance rule that may require an arrestee wellness check every 60 minutes is about to lapse. The communication may include a name or identification key of an arrestee related to the variance or the circumstances surrounding the variance. If enabled and a variance is discovered, a system alert may be triggered to be shared automatically with one or more user groups or system users.

Another customizable feature may include creation and management of system alerts related to activity records of an arrestee. For example, if no documented activities have been recorded or logged about an arrestee after a certain amount of time (e.g. 30 minutes, one hour, etc.), which time may be set by a system administrator, then an alert may be sent to one or more user groups or users. In some embodiments, a user may create, enable, or disable alerts related to time spent at locations or sub-locations. For example, if an arrestee has spent a certain amount of time (e.g. one hour, 30 minutes, etc.) at an intermediary location an alert may be sent to a user or user group. A user such as a system administrator may want to know if an arrestee has spent more than the expected amount of time at a location or sub-location. The user may have the ability to enter the maximum amount of time to be spent at a location or sub-location. If enabled, a system alert may be triggered to communicate to one or more user groups or users that the maximum amount of time is exceeded.

Another customizable feature may include assigning multiple RFID or barcode tags or labels to property of an arrestee for asset tracking. Another customizable feature may include the ability to assign RFID or barcode scanners to specified locations, sub-locations, sectors, or transport vehicles. A further customizable feature may include defining what information may be presented on the user interface when an RFID or barcode tag or label is scanned. A user such as a system administrator may choose to configure a computing device to display different information if, for example, an RFID or barcode tag such as RFID or barcode wristband 106 or RFID or barcode label 112A or 112B is scanned at an intermediary location as compared to when an RFID or barcode is scanned at a detention facility. Some systems may be helpful in documenting arrestee lapsed time at a location, attendance records, or headcounts, among others.

### Process Flow Overview

When a suspect is initially arrested, the suspect may be “tagged” by a user (e.g. a law enforcement officer or deputy) via an RFID or barcode wristband such as RFID or barcode wristband 106. A unique identification (UID) of the RFID or barcode wristband may be electronically associated with an identification key. An identification key may be, for example, a master booking number, or a unique number or value assigned by a user or system administrator to the arrestee. In some embodiments, the assignment of the master booking number may be assigned to the UID of the RFID or barcode wristband which when affixed to an arrestee associates the master booking number to the arrestee, even if the identity of the arrestee has not been received and entered into the system. The RFID or barcode wristband may contain certain pre-printed information affixed or laminated into the wristband, including a barcode representation of the identification key. This may provide auto-identification redundancy in the event that the RFID or barcode tag becomes inoperable or intentionally damaged by an arrestee.

Additionally, an RFID or barcode label may be affixed to a document such as a criminal affidavit document of an arrestee, to electronically associate the document, or any other document to be “tagged” with the identification key. The RFID or barcode label may uniquely identify the name, employee identification number, badge number, or some other number or value that identifies a user such as a law enforcement official. In some such instances, one or more wristbands may be provided to an officer for use when arresting suspects. Data associating the assigned wristbands to a user such as an arresting officer may be recorded so that the user is known and associated with a specific identification key. An RFID or barcode label may also be affixed directly to any property of the arrestee or containers such as property bags, which may be used to collect and secure arrestee property. The property of the arrestee may be sorted, for example, by groups such as cash, medicine, and general property. Each property group may be individually placed in a container, tagged, and associated with the identification key such as by affixing a label such as RFID or barcode label 112A. Arrestee property that may not fit into a property bag such as a bicycle or tent may be tagged with a barcode or RFID label without being placed in a property bag first.

In some embodiments, at or around the time an arrestee is secured the system may electronically log the name of an arresting officer such as may already be known by assignment of a wristband to the arresting officer, the agency the officer is working for, or a unique employee ID such as a badge number. In some embodiments, this log entry may be captured by scanning an RFID or barcode based ID tag of the officer, manual entry through a user interface of the system, or other data entry. In some embodiments, a user interface of the system may include a list of arresting officers and their agency names. A user may click on the corresponding name of the arresting officer on the user interface to electronically log the name or agency of the arresting officer.

A mobile application such as an application running on mobile device 102 may electronically confirm the location (e.g. sub-location, sector, or GPS coordinates) at or near which an arrestee was arrested. In some embodiments, GPS data such as GPS coordinates may be automatically captured via a mobile device. In some embodiments, a user may manually enter a description of the location. In some embodiments, an address, intersection, or some other type of manual electronic entry may be used to describe the point of arrest. In some embodiments, the system may include a location with pre-defined areas or sectors that are selectable through the user interface. In some embodiments, the pre-defined areas or sectors may be defined by a user such as a law enforcement official or a system administrator.

In some embodiments, the system may be used to capture one or more images of the arrestee such as through using a camera coupled to the network 126. The one or more images of the arrestee may be associated with the identification key assigned to the arrestee. In some embodiments, associating the image to the identification key comprises scanning an RFID or barcode label before or after a picture is taken with the camera.

Demographic information about the arrestee may optionally be captured in some embodiments. This may include a law enforcement officer using the user interface to enter the name (e.g. first and last name), address, race, or sex of the arrestee, or any other pertinent information about the arrestee.

Some embodiments may include system elements to log which transport vehicle an arrestee is assigned to. This recorded entry may be captured automatically by scanning or reading an RFID sensor or barcode assigned to the vehicle with an RFID or barcode scanner connected to a network such as network 126 and also scanning an RFID or barcode tag associated with the arrestee. In some embodiments, the system may include the date and time the entry was captured. In some embodiments, an entry may be manually entered into the system through the user interface. The user may have the ability to create a record of what time the transport vehicle departs by manual electronic entry or through an application such as a GPS application. In some embodiments, the system may allow a user to define a destination of an arrestee or transport vehicle such as transport vehicle 114.

A transport vehicle may include a mobile hotspot or portable Wi-Fi connection to the Internet enabling a mobile device on or near the transport vehicle with Internet capability to share and receive information in real-time (e.g. “synchronizing”). In some embodiments, a mobile device such as mobile device 102 may include a wired or wireless connection separate from the transport vehicle.

A transport vehicle may include an RFID or barcode reader (e.g. scanner) that may read or scan an RFID or barcode wristband of an arrestee at or around the time the arrestee boards the transport vehicle. In some embodiments, the system may create an electronic log entry that includes a time and date stamp, location ID, and vehicle ID in the system at, or around the time, the arrestee boards the transport vehicle. The RFID or barcode reader may be networked via Wi-Fi or WAN or other method of networking the system.

The destination of a transport vehicle may be a secure remote facility (e.g. intermediary or transfer station) such as staging area 116 where arrestees may be quickly and securely transferred into the custody of another law enforcement agency or remain in the custody of the same agency. For example, in many jurisdictions, county jails are operated by a county sheriff's department but an arrestee may have been arrested by a city police department, which is a distinct law enforcement agency. In some embodiments, the arrestee may be prepared at the secure remote facility for transport to a detention facility such as detention facility 118. The arrestee may be further processed at the detention facility 118. In some embodiments, the arrestee may be transported directly to the detention facility 118 from the point of arrest without the use of the secure remote facility. This may be due to a variety of factors such as the severity of the charges to be brought against the arrestee, a health condition, or gang affiliation, among others. In some embodiments, the arrestee may be transported directly to a hospital due to a health or other condition such as the arrestee being suicidal or in need of medical attention.

If the arrestee is transferred to a secure remote facility from the point of arrest, the system such as system 100 may allow a user to enter the time and date of arrival at the remote facility or transfer station into the system such as through mobile device 102 or computer 122A or 122B. In some embodiments, the system may record this information automatically, using, at least in part, GPS, the time and date of arrival at the remote detention facility, transfer station, or intermediary location.

A request made by an arrestee, such as a request for medical attention, bathroom use, or the like, may be electronically recorded. Recording may be accomplished using the mobile device 102 or computer 122A or 122B. In some embodiments, the request may be electronically recorded using pre-defined codes. The pre-defined code may be selected by a user through the user interface such as by a user clicking on a button corresponding to the request. A user may indicate whether the request made by the arrestee was honored or not. A user may record any other information pertinent to the request, through the user interface.

Similarly, a user, such as a corrections officer at a detention facility, may document that performance of certain actions such as offering an arrestee a meal and whether the arrestee accepted or declined the meal. These actions, and their corresponding responses, may be recorded via pre-defined codes (referred to as “WordBlocks”). To a user WordBlocks appear as text on a button on the user interface. A user may click on a WordBlock to record an action. WordBlocks may include text such as “Offered Arrestee Meal,” “Arrestee Declined Meal,” “Arrestee Accepted Meal,” “Arrestee Made Request,” “Bathroom,” “Medical Attention,” etc.

A system user may prepare electronic transport sheets (e.g. “load sheets”) by assigning arrestees to transport vehicles. In some embodiments, the system may allow users such as system administrators to create and manage transport vehicle characteristics such as maximum seating capacity. In some embodiments, users such as system administrators may assign an identification key to a transport vehicle for identification purposes. The identification key may be associated with an RFID or barcode label situated on the transport vehicle.

Sometime after creation of a transport sheet, a computer such as computer 122A or 122B or mobile device 102 may download the transport sheet. In some embodiments, a user may scan or read an RFID or barcode label such as RFID or barcode label 122B on the transport vehicle such as transport vehicle 114, and view a list of arrestees assigned to the transport vehicle through a user interface. This list may include a list of names, identification keys, or a combination thereof. If a name of an arrestee is unknown the arrestee may be listed under an associated identification key. In some embodiments, a user such as an officer or deputy may perform a verbal roll call or visual headcount to help confirm that the arrestees assigned to the transport vehicle are on the transport vehicle. In some embodiments, the headcount may be recorded or logged into the system such as through a user entering the headcount into mobile device 102 or computer 122A or 122B. The headcount may be used for reporting purposes.

A user such as an officer may perform an RFID or barcode tag based headcount. The user may individually scan the wristbands of arrestees associated with a transport vehicle such as transport vehicle 114. A mobile application such as an application running on mobile device 102 may display in real-time the number of completed scans or reads, as compared to the expected number of wristband scans or reads, based on the load sheet. A user may also use an RFID or barcode scanner included in the transport vehicle to read or scan a wristband associated with an arrestee. The read or scan of the wristband on the arrestee may create an electronic log entry that inserts a time and date stamp, location, or transport vehicle identification into the system. In some embodiments, the system may record, in real-time, a headcount based on the number of RFID or barcode reads or scans captured by an RFID or barcode scanner such as an RFID or barcode scanner included on a transport vehicle or a mobile device. In some embodiments, the system may transmit whether the headcount matches the number of arrestees assigned to the transport vehicle in a communication to a user device such as mobile device 102 or computer 122A or 122B. The communication may specify whether the physical count is correct or whether a variance was identified. The communication may communicate the name or identification key of an arrestee not included in the headcount.

A variance in the headcount, whether the headcount was performed visually, audibly, or by scanning the wristbands of arrestees, may create a log entry in the system such as in server 120. The entry may be used later for reporting purposes. The system may also sound or send an alert or warning to individual users or user groups indicating that a variance exists and what the circumstances of the variance are such as the name, description, last known location, or identification key of the arrestee corresponding to the variance. The server 120 may compare a lapsed time to a maximum amount of time allowed and send the alert or warning to a mobile device such as mobile device 102 or a computer such as computer 122A or 122B.

In some embodiments, a user may manually record a time of departure of a transport vehicle with mobile device 102 or computer 122A or 122B. In some embodiments, the time of departure may be recorded automatically using, at least in part, an application such as a GPS application. The time of departure may correspond to a transport vehicle such as transport vehicle 114 leaving a location such as a secure remote facility.

In some embodiments, at or around the time the transport vehicle arrives at a detention facility such as detention facility 118, a user may confirm arrival at the detention facility via a manual log entry through a computer or mobile device. In some embodiments, at or around the time the transport vehicle arrives at the detention facility, the system may automatically record a log entry using, at least in part, a GPS application. A user may scan an RFID or barcode label on the transport vehicle such as RFID or barcode label 112B. In some embodiments, scanning the RFID or barcode tag on the transport vehicle may cause a listing of all arrestees assigned to the transport vehicle to appear on a user interface such as a user interface of a mobile device or a computer. The user may perform a verbal roll call or visual headcount to determine if the number of expected arrestees assigned by a user and recorded on a load sheet matches the actual number of arrestees in the transport vehicle. The headcount may be recorded or logged in the system for future use such as reporting purposes.

In some embodiments, a user may perform an RFID or barcode wristband headcount, by scanning wristbands of arrestees. The user interface may display in real-time the number of completed scans or reads as compared to the expected number of wristband scans or reads based on a load sheet. An alert may be communicated if a variance in the expected number of scans and the actual number of scans exists.

A user may use an RFID or barcode reader of a transport vehicle to read or scan the wristbands of arrestees. In some embodiments, the read or scan may create an electronic record or log entry that includes a time and date stamp, location, or identification key associated with a transport vehicle into the system. The system may automatically record, in real-time, a headcount based on the number of RFID or barcode reads or scans captured by the RFID or barcode scanner and relay a communication of the headcount to one or more users or user groups. In some embodiments, a specific mobile device such as mobile device 102 may be assigned to a transport vehicle such as transport vehicle 114. The assigned mobile device may receive communications such as alerts, warnings, updates, or other communications. The communication may specify whether an actual count is consistent with a load sheet or whether a variance was identified. In some embodiments, a variance may trigger a communication of the name or identification key of an arrestee not included in the headcount. The communication may also include the circumstances such as the location and time the variance was discovered and the last known location of an arrestee that is on the load sheet that was not counted.

Any variances to the headcount, whether the headcount was performed visually, audibly, or by scanning the arrestee's wristbands, may create a log entry into the system for future use such as reporting purposes. A variance may trigger a communication alert or warning to either individual users or user groups. The users or user groups that receive a specific communication may be configured by a system administrator.

The system may record the total amount of time it took the arrestee to be transported from the point of arrest to arrival at the detention facility, including the specific amount of time between each segment of the transport such as between the point of arrest and an intermediary point. This may enable a user to identify, in real-time, arrestee management performance with respect to process efficiency and ensure that arrestees are transported swiftly and safely to a detention facility for processing. This may provide a legally defensible record that validates the actual time spent in custody logged at frequent intervals throughout the arrest to detention, which may protect users from frivolous lawsuits or unfounded accusations by arrestees.

At or around the time the headcount is confirmed as being accurate, the user may close out the application. Closing out the application may create a log entry into the system for future use such as reporting purposes.

### Booking Process Overview

A user such as a system administrator may create and manage sub-locations, which may be represented as “stations” to be visited or “stages” to be completed within the booking process. A user may create as many sub-locations as desired to manage the booking process. A user may configure the workflow associated with these tasks and may help ensure that the tasks are completed within a certain period of time or in a particular order. In some embodiments stations or stages may include booking, mug shot (e.g. image capture), medical, phone call, court, release, or holding stations or stages, among others.

An RFID or barcode scanner may be assigned to and associated with a stage or station. At or around the time of scanning the RFID or barcode wristband of an arrestee, a time and date stamp or location of a stage or station where the scan occurred may be logged into the system. Such logs may be for future use such as reporting purposes. In some embodiments, such a transaction may validate that an arrestee has in fact been to a particular station or stage.

In the event that an arrestee is temporarily removed from the booking process a user may record why the arrestee was removed by clicking a WordBlock (e.g. clicking a mouse button while a cursor is over a button containing text corresponding to the desired action, or touching the corresponding button on a touch screen) included in a list of WordBlocks on a user interface.

At or around the time the booking process has completed, the arrestee may be released from custody or transferred into custody of a detention facility. This action may be recorded in the system such as by server 120. The status of the arrestee may be updated to reflect that arrestee is no longer active in the system. All records pertaining to the arrestee may remain in the database for reporting purposes.

### Dashboard and Analytics Overview

In some cases, managing security for a large event is a multi-jurisdictional responsibility involving many law enforcement officers and agencies. It may be helpful to permit many users to have access to real-time or near real-time operational information to ensure assets and resources are deployed efficiently and effectively. Some example embodiments may facilitate this goal.

The system may display key performance indicators (KPIs) and analytical information. In some embodiments, the KPIs may be delivered to a user via a web or mobile application. The KPIs may be updated in real-time as data is collected and saved by the users. Example KPIs may include number of arrestees per departed transport vehicle; average total (or partial) transport time; number of arrests per location (e.g. sub-location or sector); average time spent per arrestee at a station or stage; average number of daily transports; number of daily meals accepted or declined; or a compliance rate, among others. The compliance rate may include a headcount completion rate (e.g. what percentage of transports include a successfully completed headcount); how many arrestees were offered meals that were in custody for four or more hours; or how many incidents are there where an arrestee has no activities logged that are associated with the arrestee for a specified amount of time.

A mapping module may overlay data collected from users in the field to display: a geographical point of arrest to help strategically place assets and resources; the present location of a transport vehicle in relation to a user, this may allow estimated times of arrival to be relayed to a user or a user group; or actual or estimated travel times and distances between various transport vehicle current locations and destinations such as between the point of arrest to the detention facility or an intermediary location. The system may also be configured to facilitate the creation of and display of a transport list associated with a transport vehicle.

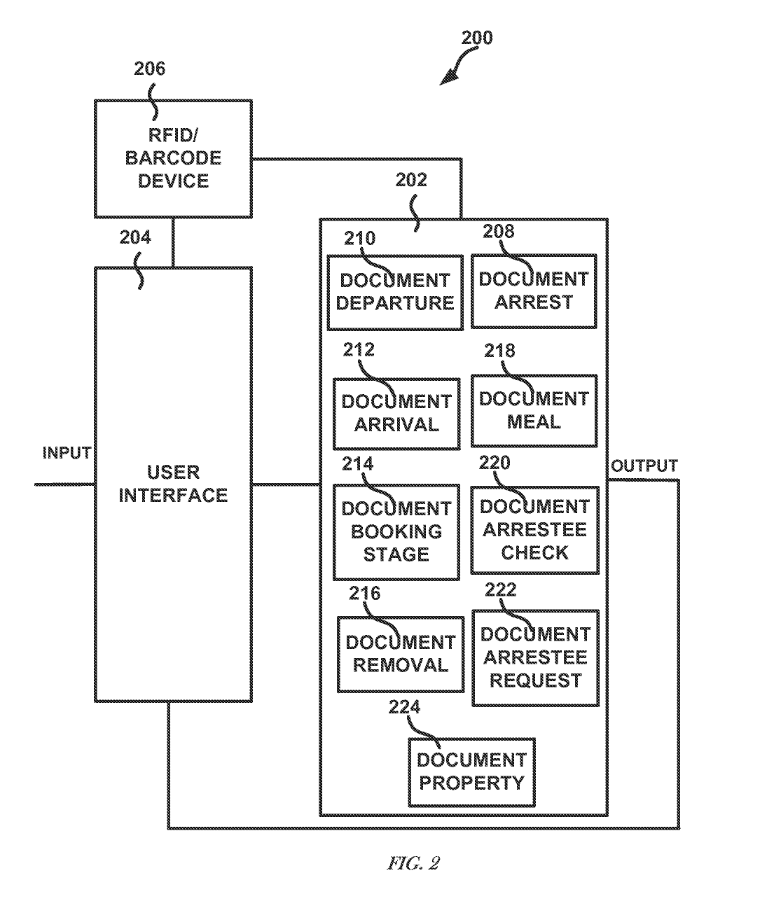

### Description of FIGS. 2-15

FIG. 2 illustrates an arrestee management system 200 according to an example embodiment. Arrestee management system 200 may include a set of functions 202, a user interface 204, and an RFID/barcode device 206.

Set of functions 202 may include a document arrest function 208, a document departure function 220, a document arrival function 222, a document booking stage function 224, a document removal function 226, a document arrestee check function 220, a document arrestee request function 222, or a document property function 224, among others. In some embodiments, the arrestee management system 200 may be operable to automatically assign arrestees to a transport and prepare a transport list. In some embodiments, the arrestee management system may allow a user to prepare a transport list such as by scanning RFID or barcode labels or manually entering data. In some embodiments, arrestees may be assigned to be transported together without designating a specific transport vehicle to the assigned arrestees. Each function may be implemented in one or more modules or more than one function may be combined and implemented in a module, and is discussed below.

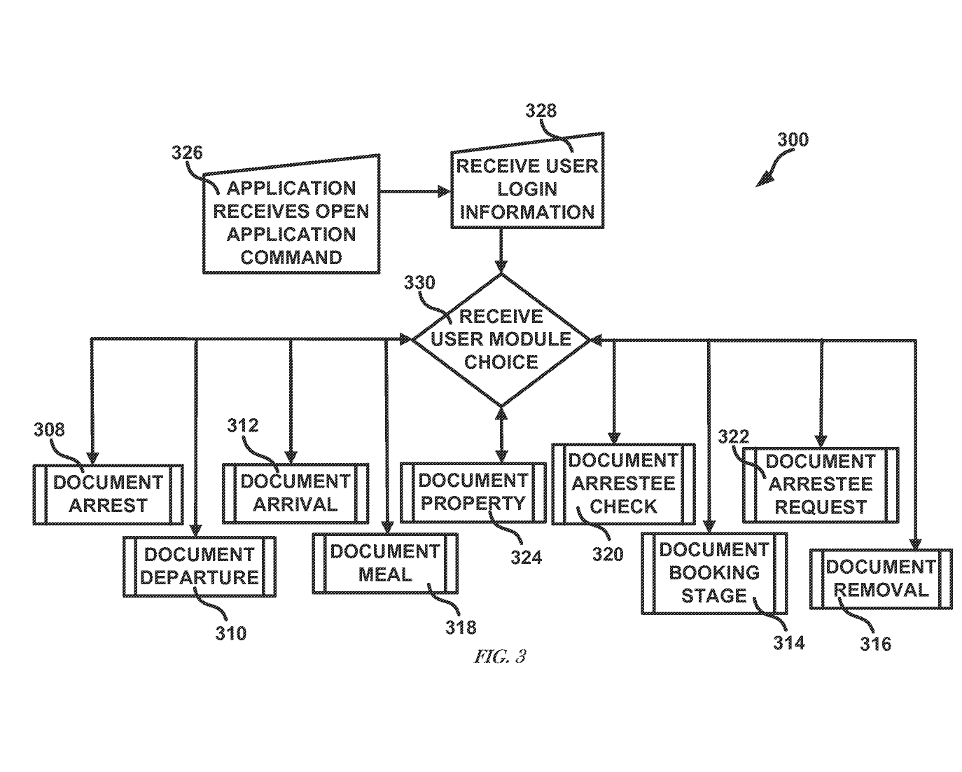

FIGS. 3-12 may include at least one numbered item that includes the term “receive.” The data or information being received in the numbered item may be received at a server, mobile device, or other computing device. For example, item 328 recites “receive user login information.” The user login information may be received at a server, mobile device, or other device operable to execute an arrestee management system application.

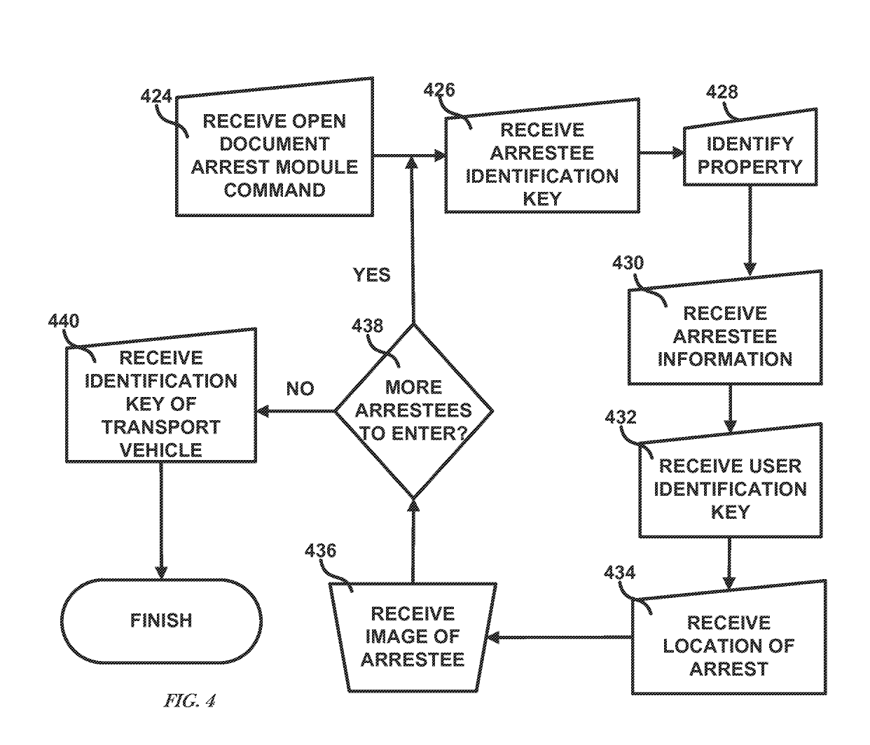

FIG. 3 illustrates a system level flowchart implemented by an arrestee management system 300, according to an example embodiment. In some embodiments, the arrestee management system 300 may begin at 326 with the application receiving an open application command. The open application command may be triggered by a user clicking or touching an application icon on a user interface or other method of opening an application. The system 300 may prompt a user for and receive user login information at 328. If the user login information is valid, that is if the received user login information corresponds to the login information of an approved user, then the system 300 may prompt a user to choose a module and receive data representative of a module chosen by the user at 330. Modules that may be chosen by a user may include a document arrest module 308, a document departure module 310, a document arrival module 312, a document booking stage module 314, a document removal module 316, a document meal module 318, a document arrestee check module 320, a document arrestee request module 322, or a document property module. A flowchart of the functions or actions implemented by each module is depicted in FIGS. 4-12, respectively, according to example embodiments. In some embodiments, a module may be Web-based.

In some embodiments, an arrestee management system 200 may include a reports module. The reports module may be configured to enable authorized system users to filter and return corresponding data in a specific format. Filters may include date, time, arrestee name, identification key, user ID, or location, among others.

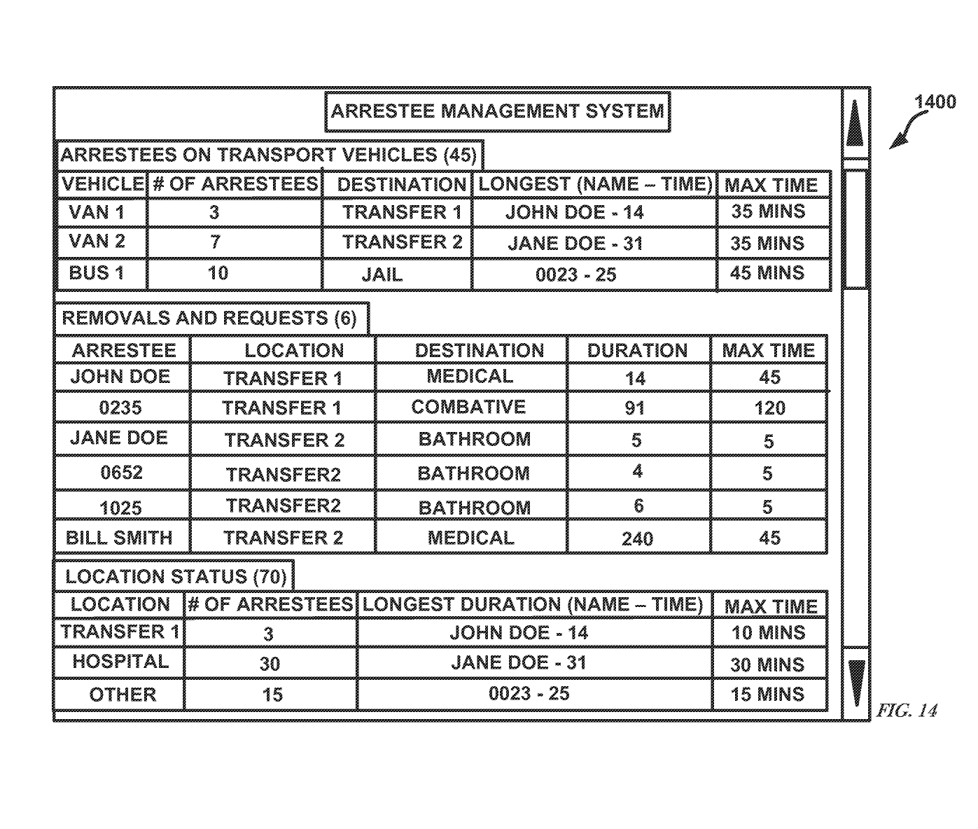

In some embodiments, an arrestee management system 200 may include a dashboard module. The dashboard may be configured to display (e.g. graphically present) a number of KPIs such as any KPI disclosed herein, including the KPIs depicted in and discussed with regard to FIG. 14, among others. In some embodiments, the dashboard may provide a high-level operational view of the arrestee management system 200. In some embodiments, the dashboard may be refreshed to reflect data in near real-time.

In some embodiments, the arrestee management system 200 may include a transport list module. The transport list module may be configured to allow system users to create and manage groups of arrestees that may be transported together on the same vehicle. In some embodiments, the arrestee groups may be automatically defined (e.g. pre-defined) by the arrestee management system 200. In some embodiments, arrestees may be assigned to a group of arrestees with the same destination. In some embodiments, arrestees may be assigned to a group of arrestees with varying destinations. For example, a group of 20 arrestees could be assigned to a single transport vehicle such as a transport bus; 18 arrestees could share a destination of “Jail,” while the two remaining arrestees could share a destination of “Hospital.”

In some embodiments, the arrestee management system 200 may include an identify property module. The identify property module may be configured to allow system users to scan an RFID or barcode label associated with personal property of a detainee to determine which arrestee the property is associated with. The system 200 may display an image of an arrestee, the name of the arrestee, or the identification of the arrestee associated with the property, after the label associated with the property has been scanned.

The transport list could be initially created by either the Web-based application, mobile application, or a user using either the Web-based application or mobile application. Updates to a transport list can be done by the arrestee management system 200. In some embodiments, either the Web or mobile application may be configured to execute the update. An update could mean that the roster of arrestees assigned to a transport vehicle has been modified, the destination of the transport vehicle has changed, or the transport vehicle ID has now been assigned (or changed), among others.

In some embodiments, an arrestee management system 200 may include an administration module. The administration module may allow only authorized system users the ability to create, manage, or edit certain functions, customize end user access to the system, or create, manage, or deactivate users, or configure the arrestee management system in a manner discussed herein.

The document arrest function 208 may be configured to manage a process of arresting a person. FIG. 4 illustrates a flowchart of a method implemented by a document arrest function 208, according to an example embodiment. In some embodiments, the document arrest function 208 may be triggered to begin at or around the time the document arrest function receives an open document arrest function command 424. The open document arrest function command may be received through a user clicking on a document arrest function icon on the user interface 204 or touching document arrest function icon on the user interface or other method of opening an application. The document arrest function 208 may be configured to prompt a user for or receive data representative of an identification key associated with an arrestee 426. The identification key may be received through a user entering the identification key manually or through a user scanning an RFID or barcode tag or label associated with an arrestee using RFID/barcode device 206. In some embodiments, the document arrest function 208 may be configured to prompt a user for or receive data representative of property of an arrestee 428. In some embodiments, the document arrest function 208 may be configured to prompt a user for or receive data representative of demographic information about an arrestee 430. Demographic information may include age, sex, hair color, eye color, height, weight, nationality, or other demographic information. The document arrest function 208 may be configured to prompt a user for or receive data representative of personal property of an arrestee in, or eventually to be in, law enforcement possession. The document arrest function 208 may be configured to prompt a user for or receive data representative of an identification key associated with an arresting official (e.g. a user) of the first arrestee 432. The document arrest function 208 may be configured to prompt a user for or receive data representative of the location where the first arrestee was arrested 434. In some embodiments, the document arrest function 208 may be configured to prompt a user for or receive data representative of an image of the first arrestee 436. The document arrestee function 208 may be configured to prompt a user for or receive data representative of a transport vehicle that an arrestee may be assigned to 440. In some embodiments, the document arrest function may be configured to prompt a user for or receive data representative of a destination of the transport vehicle the arrestee is assigned to. The document arrest function 208 may be configured to prompt a user for or receive data representative of whether more arrestees are to be entered 438.

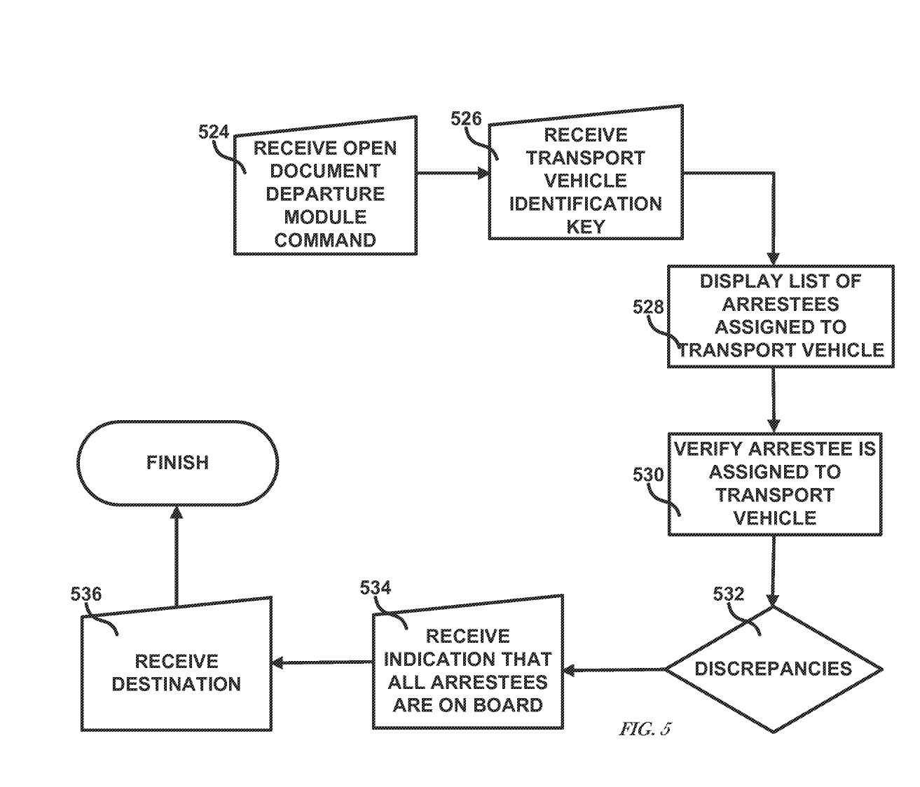

The document departure function 210 may be configured to manage a process of preparing a transport vehicle for departure and help verify that all arrestees are on the transport vehicle prior to departure. FIG. 5 illustrates a flowchart of a method implemented by a document departure function 210, according to an example embodiment. In some embodiments, the document departure function 210 may be triggered to begin at or around the time the document departure function receives an open document departure function command 524. The open document departure function command may be received through a user clicking on a document departure function icon on the user interface 204 or touching a document departure function icon on the user interface or other method of opening an application. The document departure function 210 may be configured to prompt a user for and receive data representative of an identification key of a transport vehicle to transport arrestees 526. The identification key may be received through a user entering the identification key manually or through a user scanning an RFID or barcode tag or label associated with an arrestee using an RFID/barcode device 206. The document departure function 210 may be configured to provide data representative of a list of arrestees assigned to the transport vehicle 528 to the user. The data representative of a list of arrestees may be presented to a user through the user interface 204. The document departure function 210 may be configured to prompt a user for and receive data representative of an indication that all the arrestees assigned to the transport vehicle are on the transport vehicle 534. The document departure function 210 may be configured to compare a list of arrestees assigned to the transport vehicle to a list of arrestees on the transport vehicle 530. The document departure function 210 may be configured to compare a number of arrestees assigned to the transport vehicle to a number of arrestees on the vehicle. The number of arrestees on the vehicle may be prompted for and received by the document departure function 210. A user may count the number of arrestees on the transport vehicle prior to entering the number of arrestees on the vehicle into the user interface. The count may be ascertained through an audible roll call or a visual headcount. The document departure function 210 may indicate to a user through the user interface 204 that a discrepancy between the list of arrestees assigned to the transport vehicle and the arrestees on the transport vehicle exists 532. The document departure function 210 may prompt a user to scan a barcode or RFID tag associated with each arrestee on the transport vehicle. The list of arrestees may be created, in part, by a user scanning an RFID or barcode tag associated with each arrestee on the transport vehicle. The document departure function may be configured to prompt a user for and receive data representative of a destination of the transport vehicle 536.

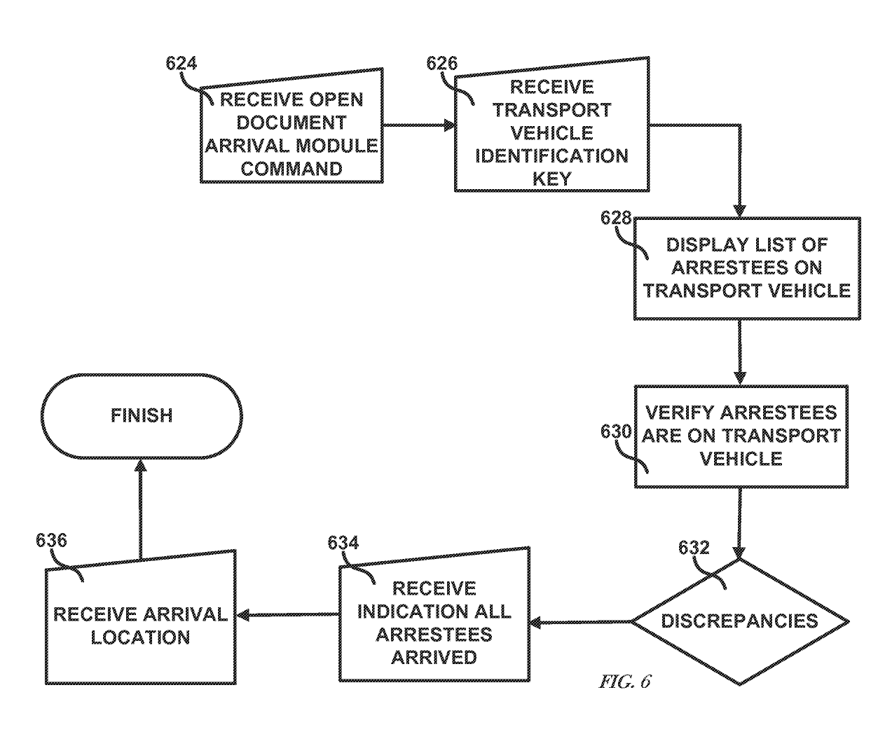

The document arrival function 212 may be configured to manage a process of removing an arrestee from the transport vehicle at a destination of the transport vehicle and help verify that all arrestees on the transport vehicle prior to transport are on the transport vehicle at the destination. FIG. 6 illustrates a flowchart of a method implemented by a document arrival function 212. In some embodiments, the document arrival function 212 may be triggered to begin at or around the time the document arrival function receives an open document arrival function command 624. The open document arrival function command may be received through a user clicking on a document arrival function icon on the user interface 204 or touching document arrival function icon on the user interface or other method of opening an application. The document arrival function 212 may be configured to prompt a user for and receive data representative of the identification key of the transport vehicle 626. The identification key may be received through a user entering the identification key manually or through a user scanning an RFID or barcode tag or label associated with an arrestee using an RFID/barcode device 206. The document arrival function 212 may be configured to compare a list of arrestees on the vehicle prior to transport to a list or arrestees on the transport vehicle at or around the time the transport vehicle arrived at the destination 628. The document arrival function 212 may be operable to compare a number of arrestees on the transport vehicle prior to departure to a number of arrestees on the vehicle at around the time the transport vehicle arrived at the destination 630. The number of arrestees on the transport vehicle at the destination may be prompted for and received by the document arrival function 212. A user may count the number of arrestees on the transport vehicle prior to entering the number of arrestees on the vehicle into the user interface. The count may be ascertained through an audible roll call or a visual headcount. The document arrival function 212 may be configured to prompt a user for and receive data representative of an indication that the arrestees on the list of arrestees on the transport vehicle prior to transport were on the transport vehicle at or around the time the transport vehicle arrived at the destination. The document arrival function 212 may indicate to a user through the user interface 204 that a discrepancy between the list of arrestees on the transport vehicle prior to transport and the arrestees on the transport vehicle at the destination exists 632. The document arrival function 212 may prompt a user to scan a barcode or RFID tag associated with each arrestee on the transport vehicle. The list of arrestees on the transport vehicle at or around the time the transport vehicle arrived at the destination may be created, in part, by a user scanning an RFID or barcode tag associated with each arrestee on the transport vehicle. The document arrival function 212 may be configured to prompt a user for and receive data representative of an indication that all arrestees on the transport vehicle prior to departure arrived at the destination 634. The document arrival function 212 may be configured to prompt a user for and receive data representative of where the transport vehicle arrived 636. A destination of the transport vehicle may include an intermediary location, a booking station, or a detention facility, among others.

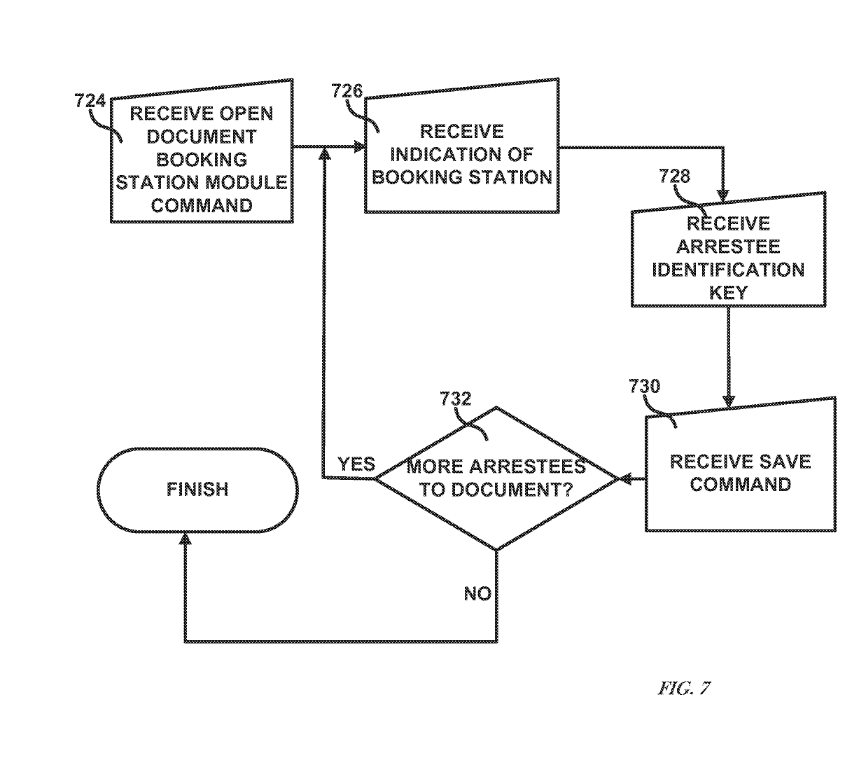

The document booking stage function 214 may be configured to manage a process of booking an arrestee. FIG. 7 illustrates a flowchart of a method implemented by a document booking stage function 214. In some embodiments, the document booking stage function 214 may be triggered to begin at or around the time the document booking stage function receives an open document booking stage function command 724. The open document booking stage function command may be received through a user clicking on a document booking stage function icon on the user interface 204 or touching document booking stage function icon on the user interface or other method of opening an application. The document booking stage function 214 may be configured to prompt a user for and receive data representative of an identification key of an arrestee 728. The identification key may be received through a user entering the identification key manually or through a user scanning an RFID or barcode tag or label associated with an arrestee using an RFID/barcode device 206. The document booking stage function 214 may be configured to prompt a user for and receive data representative of which booking stage (e.g. booking station) is being used to book the arrestee 726. The booking stage may be a location, a name of a building, or a sub-location within a location, among others. The booking station may be received via a user clicking on a button corresponding to the booking station. In some examples, the booking stage function 214 may be configured to prompt a user for and receive data representative of whether or not to save the entries received 730 by the document booking stage module 214. In some embodiments, an arrestee management system may be configured to automatically save changes and entries made through the user interface or other parts of the system. The booking stage function 214 may be configured to prompt a user for and receive data representative of whether there are currently more arrestees to document 732.

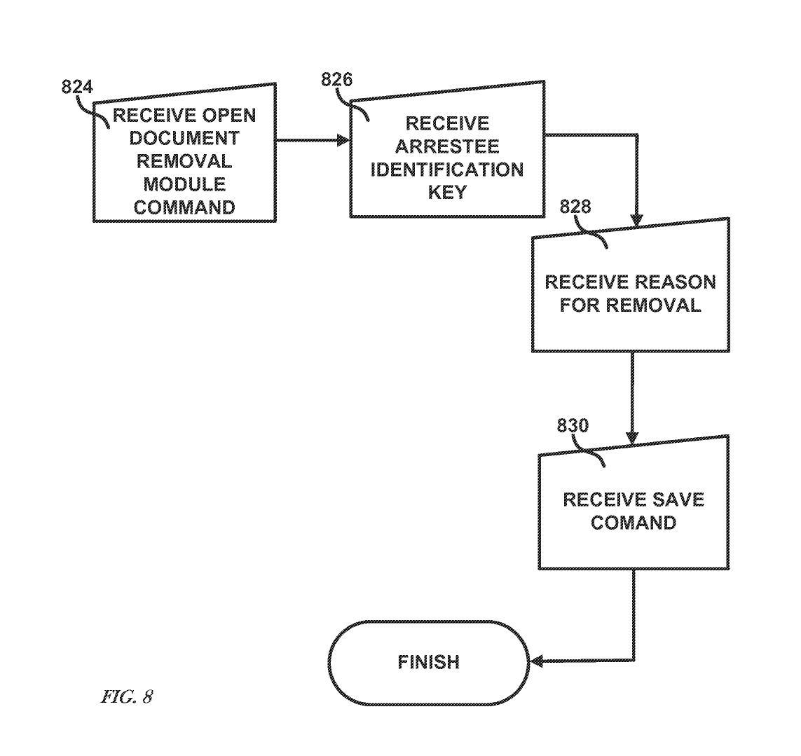

The document removal function 216 may be configured to manage a process of removing an arrestee from arrest. FIG. 8 illustrates a flowchart of a method implemented by a document removal function 216. In some embodiments, the document removal function 216 may be triggered to begin at or around the time the document removal function receives an open document removal function command 824. The open document removal function command may be received through a user clicking on a document removal function icon on the user interface 204 or touching document removal function icon on the user interface or other method of opening an application. The document removal function 216 may be configured to prompt a user for and receive data representative of an identification key of an arrestee 826. The identification key may be received through a user entering the identification key manually or through a user scanning an RFID or barcode tag or label associated with an arrestee using an RFID/barcode device 206. The document removal function 216 may be configured to prompt a user for and receive data representative of a reason to remove (e.g. permanently or temporarily) the arrestee from arrest (e.g. custody) 828. The reason for removal may be received by the document removal function 216 through a user clicking a button corresponding to the reason that may appear on the user interface 204. The reason for removal may be received by the document removal function 216 through a user entering the reason for removal manually such as by typing in the reason on a keyboard, keypad, or touch screen electrically coupled to the user interface. In some embodiments, the reason for removal may be accompanied by a list of locations associated with the reason for removal. The location may correspond to the destination of the arrestee for the removal. For example, a reason for removal including medical attention may be accompanied by the location hospital. In some embodiments, the document removal function 216 may be configured to prompt a user for and receive data representative of whether to save the entry 830 received by the document removal function 216.

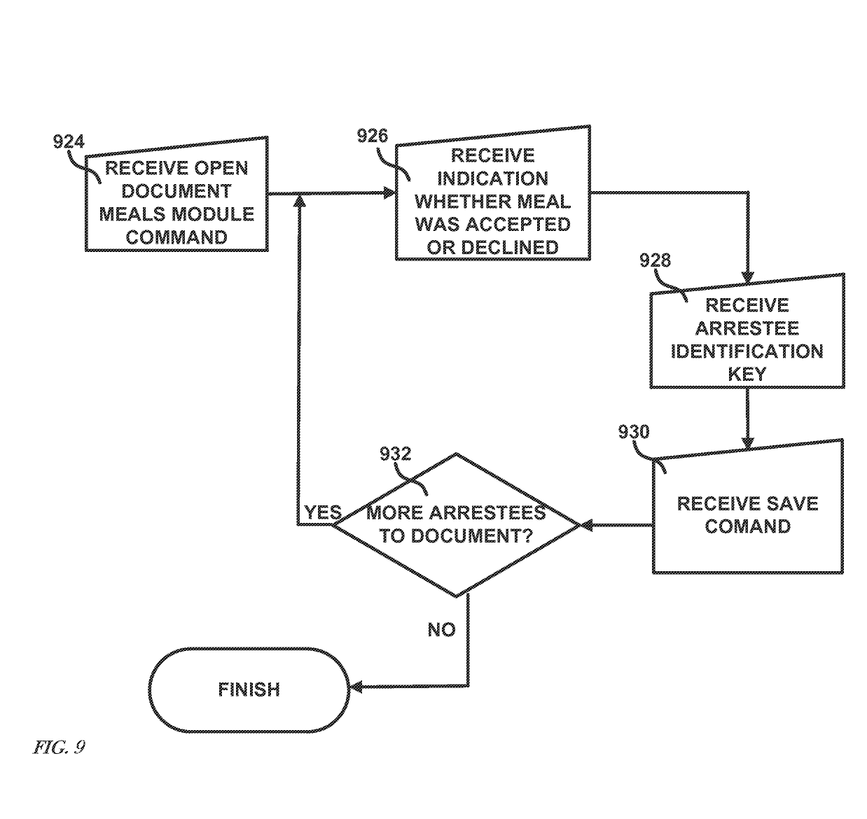

The document meal function 218 may be configured to manage a process of offering meals to an arrestee or recording an arrestee's response to being offered a meal. FIG. 9 illustrates a flowchart of a method implemented by a document meal function 218. In some embodiments, the document meal function 218 may be triggered to begin at or around the time the document meal function receives an open document meal function command 924. The open document meal function command may be received through a user clicking on a document meal function icon on the user interface 204 or touching document meal function icon on the user interface or other method of opening an application. The document meal function 218 may be configured to prompt a user for and receive data representative of an identification key of an arrestee 928. The identification key may be received through a user entering the identification key manually or through a user scanning an RFID or barcode tag or label associated with an arrestee using an RFID/barcode device 206. The document meal function 218 may be configured to prompt a user for and receive data representative of whether an arrestee accepted or declined an offer for a meal 926. The data representative of whether an arrestee accepted or declined an offer for a meal may be received by the document meal function 218 through a user clicking a button corresponding to whether the arrestee accepted or declined the meal that may appear on the user interface 204. The data representative of whether an arrestee accepted or declined an offer for a meal may be received by the document meal function 218 through a user manually entering such as through using a keyboard, keypad, or touch screen electrically coupled to the user interface 204 whether the arrestee accepted or declined the meal. In some embodiments, the document meal function 218 may be configured to prompt a user for and receive data representative of whether to save the entry 930 received by the document meal function 218. The document meal function 218 may be configured to prompt a user for and receive data representative of whether another meal offering is to be currently documented 932. The data representative of whether another meal offering is to be currently documented may be received by the document meal function 218 through a user clicking a button corresponding to whether another meal is to be or was offered or not. The data representative of whether another meal offering is to be currently documented may be received by the document meal function 218 through a user manually entering whether another meal is to be or was offered or not.

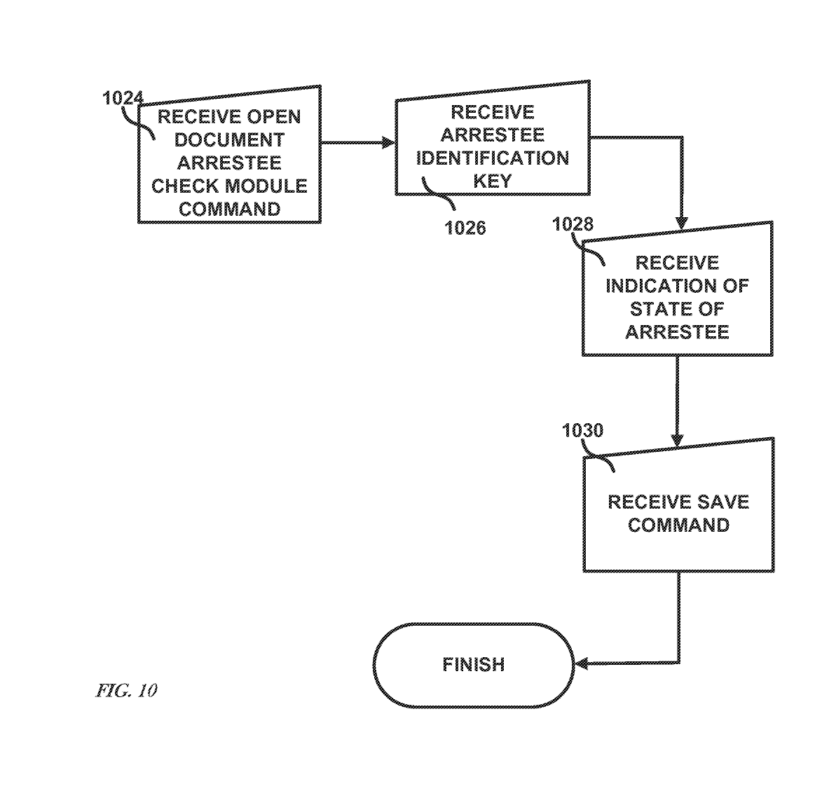

The document arrestee check function 220 may be configured to manage a process of visually or audibly checking on or inspecting an arrestee. FIG. 10 illustrates a flowchart of a method implemented by a document arrestee check function 220. In some embodiments, the document arrestee check function 220 may be triggered to begin at or around the time the document arrestee check function receives an open document arrestee check function command 1024. The open document arrestee check function command may be received through a user clicking on a document arrestee check function icon on the user interface 204 or touching document arrestee check function icon on the user interface or other method of opening an application. The document meal function 220 may be configured to prompt a user for and receive data representative of an identification key of an arrestee 1026. The identification key may be received through a user entering the identification key manually or through a user scanning an RFID or barcode tag or label associated with an arrestee using an RFID/barcode device 206. The document arrestee check function 220 may be configured to prompt a user for and receive data representative of the physical or mental state or appearance of the arrestee 1028. The data representative of the physical or mental state or appearance of the arrestee may be received by the document arrestee check function through a user clicking a button corresponding to the arrestee physical or mental state of appearance that may appear on the user interface 204. The data representative of the physical or mental state or appearance of the arrestee may be received by the document arrestee check function through a user manually entering the arrestee physical or mental state. The physical or mental state or appearance of the arrestee may be determined through a user's audible or visible inspection. In some embodiments, the document arrestee check 220 may be configured to prompt a user for and receive data representative of whether or not to save an entry received 1030 by the document arrestee check function 220.

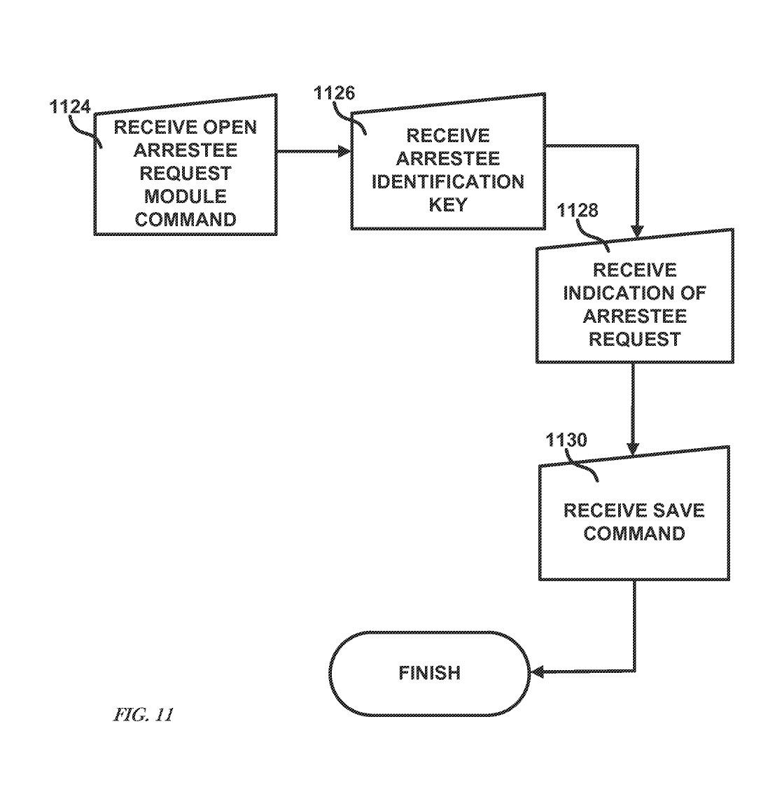

A document arrestee request function 222 may be configured to manage a process of documenting a request made by an arrestee. FIG. 11 illustrates a flowchart of a method implemented by a document arrestee request function 222. In some embodiments, the document arrestee request function 222 may be triggered to begin at or around the time the document arrestee request function receives an open document arrestee request function command 1124. The open document arrestee request function command may be received through a user clicking on a document arrestee request function icon on the user interface 204 or touching document arrestee request function icon on the user interface or other method of opening an application. The document arrestee request function 222 may be configured to prompt a user for and receive data representative of an identification key of an arrestee 1126. The identification key may be received through a user entering the identification key manually or through a user scanning an RFID or barcode tag or label associated with an arrestee using an RFID/barcode device 206. The document arrestee request function 222 may be configured to prompt a user for and receive data representative of the request made by an arrestee 1128. The data representative of the request made by the arrestee may be received by the document arrestee request function 222 through a user clicking a button corresponding to the request made by the arrestee that may appear on the user interface 204. The data representative of the request made by the arrestee may be received by the document arrestee request function 222 through a user manually entering the arrestee physical or mental state. In some embodiments, the receive arrestee request function 222 may be configured to prompt a user for and receive data representative of whether to save an entry received 1130 by the document arrestee request function 222.

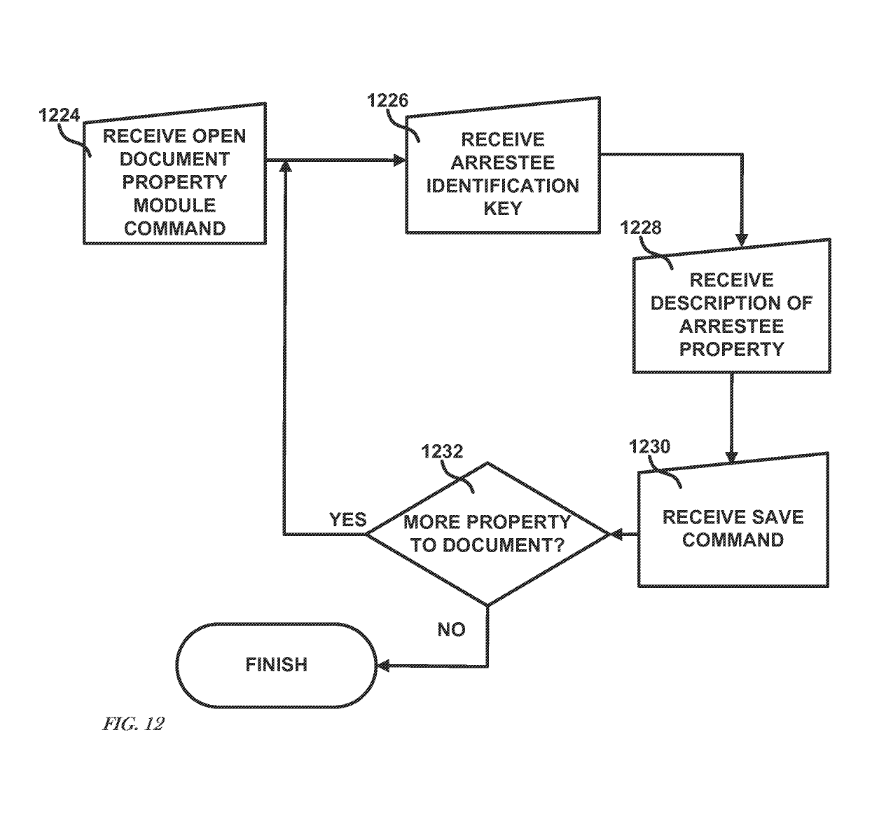

A document property function 224 may be configured to manage a process of documenting the property of an arrestee. FIG. 12 illustrates a flowchart of a method implemented by a document property function 224. In some embodiments, the document property function 224 may be triggered to begin at or around the time the document arrestee request function receives an open document arrestee request function command 1224. The open document property function command may be received through a user clicking on a document property function icon on the user interface 204 or touching document property function icon on the user interface or other method of opening an application. The document property function 224 may be configured to prompt a user for and receive data representative of an identification key of an arrestee 1226. The identification key may be received through a user entering the identification key manually or through a user scanning an RFID or barcode tag or label associated with an arrestee using an RFID/barcode device 206. The document property function 224 may be configured to prompt a user for and receive data representative of a description of property of an arrestee 1228. The data representative of the description of property of the arrestee may be received by the document arrestee request function 224 through a user clicking a button corresponding to the category of property (e.g. cash, medication, or other) the property of the arrestee is on the user interface 204. The data representative of the description of property of the arrestee may be received by the document property function 224 through a user manually entering the description of the property of the arrestee. In some embodiments, the document property function 224 may be configured to prompt a user for and receive data representative of whether to save an entry received 1230 by the document property function 224. The document property function 224 may be configured to prompt a user for and receive data representative of whether there is currently more property to document 732.

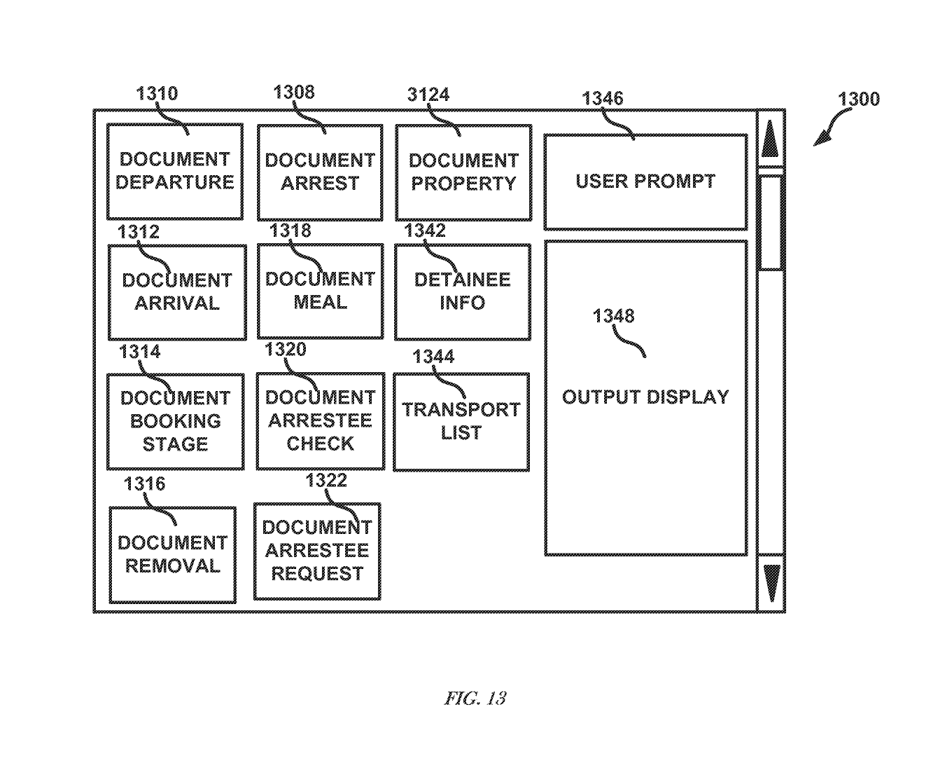

FIG. 13 illustrates a user interface according to an example embodiment. The user interface may include buttons corresponding to functions or modules that a user may select. Function or module buttons may include a document arrest button 1308, document departure button 1310, document arrival button 1312, document booking stage button 1314, document removal button 1316, document arrestee check button 1320, document arrestee request button 1322, document property button 1324, arrestee information button 1342, and transport list button 1344, among others.

At or around the time a user clicks on a function or module button a corresponding open function or module command may be sent to the corresponding module or function. For example, if a user clicks on the document arrest button 1308 an open document arrest function command may be sent to the document arrest function 208.

Clicking on document property button 1340 may cause the user interface 1340 to display prompt to a user to enter a description of property and an identification key associated with the arrestee who possesses the property using user prompt 1346.

Clicking on arrestee information button 1342 may cause the user interface 1340 to display a prompt to a user to enter demographic or other relevant information about an arrestee using user prompt 1346.

Clicking on transport list 1344 may cause the user interface 1140 to display a prompt to a user to enter an identification key associated with a transport vehicle using user prompt 1346. The list of arrestees assigned to or on a transport vehicle may be displayed using output display 1348.

FIG. 14 illustrates an output display 1400 of a system according to an example embodiment. The output display 1400 may display statistics and other pertinent information regarding arrestees at locations, sub-locations, or intermediary locations. In the illustrated embodiment a summary of arrestees on transport vehicles, removal and request made by arrestees, and the status of locations are presented using output display 1400. Other statistics or pertinent information which may be displayed on output display 1400 includes a number of arrestees by location (e.g. sub-location or sector); number or arrestees by date range (or current day); number of active or finished transports including time of departure, destination of transport, or estimated time of arrival; number of arrests by transport vehicle by date range (or current day); or current location of transport vehicles or other assets on a Web-based map. Any other information that may be recorded by a system disclosed herein may be presented using the output display 1400.

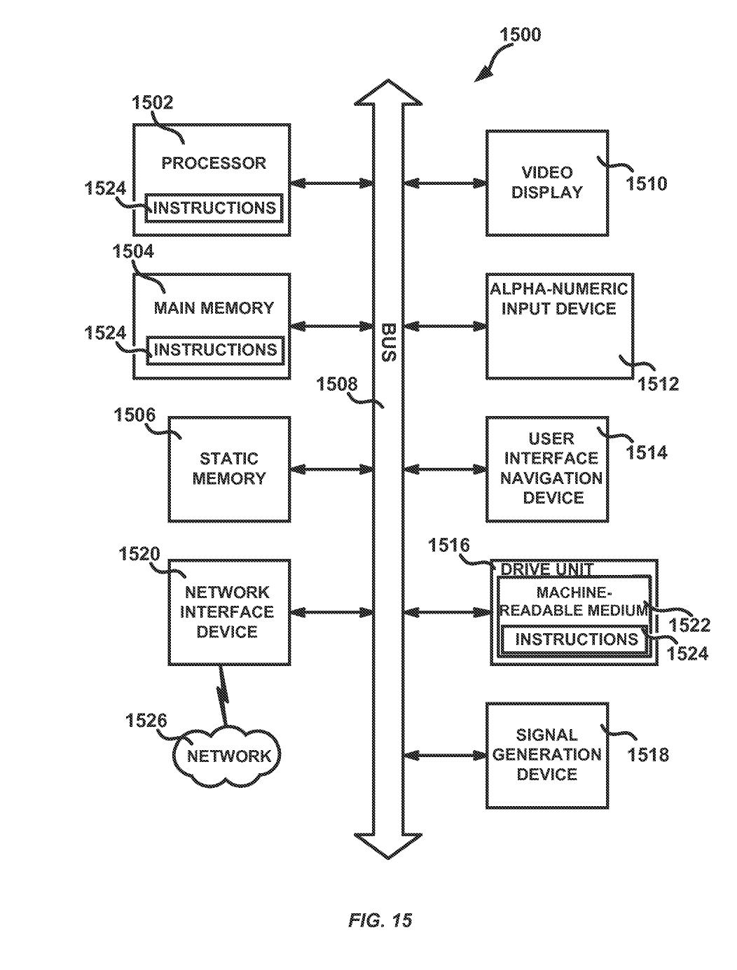

FIG. 15 illustrates a block diagram of a computer system 1500 to implement systems of the present disclosure. The computer system 1500 may include instructions 1524, for causing a machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The illustrated computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 300 also includes an alphanumeric input device 1512 (e.g., a keyboard), a user interface (UI) navigation device 1514 (e.g., a mouse), a disk drive unit 1516, a signal generation device 1518 (e.g., a speaker) and a network interface device 1520.

The disk drive unit 1516 includes a machine-readable medium 1522 on which is stored one or more sets of instructions and data structures (e.g., software) 1524 embodying or utilized by any one or more of the methodologies or functions described herein. The instructions 1524 may also reside, completely or at least partially, within the main memory 1504 and/or within the processor 1502 during execution thereof by the computer system 1500, the main memory 1504 and the processor 1502 constituting machine-readable media.

While the machine-readable medium 1522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific embodiments of machine-readable media include non-volatile memory, including by way of example, semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 1524 may further be transmitted or received over a communications network 1526 using a transmission medium. The instructions 1524 may be transmitted using the network interface device 1520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi and WiMax networks). The term “transmission medium” shall be taken to include any intangible medium that is capable of storing, encoding or carrying instructions for execution by the machine, and includes digital or analog communications signals or other intangible media to facilitate communication of such software.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the disclosed subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A system comprising:
at least one processor and at least one memory device;
a document arrest module stored in a memory device of the at least one memory device and executable by the at least one processor to manage an arrest process;
a document departure module stored in a memory device of the at least one memory device and executable by the at least one processor to manage a process of preparing a transport vehicle for departure and help verify that all arrestees are on the transport vehicle prior to departure; and
a document arrival module stored in a memory device of the at least one memory device and executable by the at least one processor to manage a process of removing an arrestee from the transport vehicle at a destination of the transport vehicle and help verify that all arrestees on the transport vehicle prior to transport are on the transport vehicle at the destination.

2. The system of claim 1, further comprising a document booking stage module stored in a memory device of the at least one memory device and executable by the at least one processor to manage a process of booking an arrestee.

3. The system of claim 1, further comprising a document removal module stored in a memory device of the at least one memory device and executable by the at least one processor to manage a process of removing an arrestee from arrest.

4. The system of claim 1, further comprising a document meals module stored in a memory device of the at least one memory device and executable by the at least one processor to manage a process of offering a meal to an arrestee.

5. The system of claim 1, further comprising a document arrestee check module stored in a memory device of the at least one memory device and executable by the at least one processor to manage a process of checking on an arrestee.

6. The system of claim 1, further comprising a document arrestee request module stored in a memory device of the at least one memory device and executable by the at least one processor to manage a process of documenting a request made by an arrestee.

7. The system of claim 1, further comprising an RFID scanner coupled to the at least one processor to scan an RFID tag associated with the arrestee, an arresting official, or the transport vehicle.

8. A method comprising:
receiving and recording, at a server, data representative of an identification key of an arrestee and data representative of at least one of a location where the arrestee was arrested, an image of the arrestee, an identification key of a transport vehicle to transport the arrestee, and a destination of the transport vehicle;
adding, with the server, the identification key of the arrestee to a transport list associated with the transport vehicle; and
sending the transport list from the server to a mobile device.

9. The method of claim 8, further comprising:
receiving, at the server, data representative of identification keys of arrestees on the transport vehicle at the destination of the transport vehicle; and
comparing the data representative of the identification keys of arrestees on the transport vehicle at the destination of the transport vehicle to identification keys on the transport list.

10. The method of claim 9, further comprising:
when a discrepancy between the identification keys of arrestees on the transport vehicle at the destination of the transport vehicle and the identification keys on the transport list exists then:
sending, from the server, an alert to the mobile device, the alert including a communication that the discrepancy exists and the identification key of the arrestee that caused the discrepancy; and
determining and recording, at the server, a date and time the discrepancy was discovered, an arrestee that caused the discrepancy and the alert that was sent to the mobile device.

11. The method of claim 10, further comprising:
receiving and recording, at the server, data representative of property of the arrestee.

12. The method of claim 11, further comprising:
receiving and recording, at the server, data representative of at least one of a physical, mental, or emotional state of the arrestee.

13. The method of claim 12, further comprising:
receiving and recording, at the server, data representative of a user offering a meal to the arrestee and data representative of whether the arrestee accepted the offering.

14. The method of claim 13, further comprising:
creating, using the server, a report based on at least some of the data recorded at the server.

15. A machine readable storage device that stores instructions, the instructions, which when performed by a machine, cause the machine to perform operations comprising:
receiving and recording data representative of an identification key of an arrestee and data representative of at least one of a location where the arrestee was arrested, an image of the arrestee, an identification key of a transport vehicle to transport the arrestee, and a destination of the transport vehicle;
adding the identification key of the arrestee to a transport list associated with the transport vehicle; and
sending the transport list to a mobile device.

16. The machine readable storage device of claim 15, wherein the instructions include instructions which when performed by the machine, cause the machine to perform operations further comprising:
receiving data representative of identification keys of arrestees on the transport vehicle at the destination of the transport vehicle; and
comparing the data representative of the identification keys of arrestees on the transport vehicle at the destination of the transport vehicle to identification keys on the transport list.

17. The machine readable storage device of claim 15, wherein the instructions include instructions which when performed by the machine, cause the machine to perform operations further comprising:
when a discrepancy between the identification keys of arrestees on the transport vehicle at the destination of the transport vehicle and the identification keys on the transport list exists then:
sending an alert to the mobile device, the alert including a communication that the discrepancy exists and the identification key of the arrestee that caused the discrepancy; and
determining and recording a date and time the discrepancy was discovered, an arrestee that caused the discrepancy, and the alert that was sent to the mobile device.

18. The machine readable storage device of claim 15, wherein the instructions include instructions which when performed by the machine, cause the machine to perform operations further comprising:
receiving and recording data representative of property of the arrestee.

19. The machine readable storage device of claim 15, wherein the instructions include instructions which when performed by the machine, cause the machine to perform operations further comprising:
receiving and recording data representative of at least one of a physical, mental, or emotional state of the arrestee.

20. The machine readable storage device of claim 15, wherein the instructions include instructions which when performed by the machine, cause the machine to perform operations further comprising:
creating a report based on at least some of the data recorded.
